(19) United States
(12) Patent Application Publication
(10) Pub. No.: US 2009/0249758 A1
(43) Pub. Date: Oct. 8, 2009

(54) Sidewinder Fence Mower

(76) Inventor: Darryll Duane Weeden, Gainesville, TX (US)

Correspondence Address: WILSON DANIEL SWAYZE, JR., 3804 CLEARWATER CT., PLANO, TX, 75025, US

(21) Appl. No.: 12/099,409

(22) Filed: Apr. 8, 2008

(51) Int. Cl. A01D 34/84; A01D 34/63

(52) U.S. Cl. 56/15.7

(57) ABSTRACT

A mower for cutting grass and which is attached to a vehicle may include a mounting frame member for connecting to the vehicle, a rotatable mowing member to rotate behind a vertical obstacle, a swingarm member to connect to the mounting frame member and the rotatable mowing member. The mower may include a biasing member to bias the rotatable mower member, and the biasing member may include a spring to bias the rotatable mower member. The mower may include a hitch connecting member to connect to the frame member, and mower may include a long arm member to connect to the rotatable mower member. The long arm member may be connected to a movable arm member to move the rotatable mower member, and the long arm member may be connected to a traverse arm member. The rotatable mower member may include a round shaft member to allow the rotatable mower member to move in and out and under the fence and around the obstacle, and the rotatable mower member may include a hydraulic mower. The rotatable mower member may include a blade, and the rotatable mower member may include a blade mounting plate member to mount the blade.

### FIELD OF INVENTION

The present invention relates to a device for mowing grass including a fence mower to be able to mow around at least three sides of a fence and under the fence.

### BACKGROUND

Tractors are often employed with many accessory implements, such as mowers, tillers, rakes, feeders, plows, grapples, post-hole diggers, post drivers, drillers, cultivators, spray booms, dozer blades, and similar apparatuses.

In the case of mowers, many improvements are designed to embrace the situation of mowing around and close to fences, fence posts, guardrails, and other vertical objects that impair clear pathway mowing whether for highway right-of-ways, parks, commercial properties, or general agriculture uses. The efficiency improvement in not having to employ a separate hand controlled trimmer is obvious.

Often a system to handle mowing around a fence with posts is designed to mow simultaneously on both sides of the fence. That is, some mechanical arrangement extending over the fence is provided to position two mower heads, one on each side, of the fence while the tractor moves along parallel to the fence row. This arrangement is expensive while subject to much maintenance and is difficult to control on rough ground, such as is common along roadways.

Various hitch assemblies are employed to serve as an intermediate mechanism between the tractor and the operating implement. Often these hitches utilize the power takeoff, usually referred to as the PTO, system of the tractor, sometimes directly and sometimes to operate a transitional power unit, such as a hydraulic system or an electrical generator. For instance, mowers often use belt-driven assemblies coming directly from the PTO, but they also are designed with hydraulic or electrical motors to drive the mower blades and these systems are powered by the tractor in some manner. However an alternate arrangement is to provide a trailer system containing a separate engine to drive the implement.

Another important situation occurs depending upon the ease of installing and removing a tractor hitch as well as its transition in use between several implements. Thus a general purpose or universal, versatile forward hitch is needed such as the subject invention provides.

One difficulty in employing agriculture implements occurs when rough ground is encountered. Of course, the operator can always manually adjust operating conditions for rough ground situations, but this is time consuming and often produces unsatisfactory results. The subject invention compensates for rough ground situations as part of the hitch system which employs various applications of torsional links.

Related United States patents include:

U.S. Pat. No. 5,960,614 Jones U.S. Pat. No. 5,425,224 1995 Downey et al. U.S. Pat. No. 5,129,218 1992 Youngberg et al. U.S. Pat. No. 5,035,107 1991 Scarborough U.S. Pat. No. 4,901,508 1990 Whatley U.S. Pat. No. 4,697,405 1987 DeWitt et al. U.S. Pat. No. 4,181,181 1980 Old U.S. Pat. No. 3,754,383 1973 Burrough et al. U.S. Pat. No. 3,701,238 1972 Hintze, Jr.

Referring to the above list, Downey et al. disclose a conventional mower deck with a moveable in-and-out carriage positioned under a tractor so as to mow close to fences.

Youngberg et al. disclose the use of torsional suspension bars on the tractor frame to tilt it for use on sloping terrain.

Scarborough discloses a rotary lawn mower having an arm with a moveable trimming attachment so as to mow close to fences.

Whatley discloses a mower using a horizontal boom with a pivotal mower head attached so as to mow close to fences and hill sides. The mower head has three separate cutting heads arranged around a central shaft which rotates only by impacting a fence post.

DeWitt et al. disclose a trailer mounted mower with multiple mower heads. One set of moveable mower heads extends on the outside of a fence row. Another moveable mower head is employed on the inside of the fence row.

Old discloses a three-point hitch to operate an implement on the front of a tractor and is designed to minimize side-to-side sway of the tractor.

Burrough et al. disclose a torsional spring suspension for a sickle-bar mower designed to raise it for transport.

Hintze, Jr. discloses a four element sickle-bar cutting mower having the ability to rotate only when impacted so as to partly curl around a fence post.

Jones discloses a system consisting of a versatile hitch attached to a tractor which positions a ground-based implement, such as a mower, in front or to either side of the tractor. The hitch cushions or dampens movement using a torsional component over rough ground by the tractor allowing the implement to traverse a near parallel ground direction. The mower design mows either normally over open ground or in restricted locations, such as around fences supported by posts.

### SUMMARY

A mower for cutting grass and which is attached to a vehicle may include a mounting frame member for connecting to the vehicle, a rotatable mowing member to rotate behind a vertical obstacle, a swingarm member to connect to the mounting frame member and the rotatable mowing member.

The mower may include a biasing member to bias the rotatable mower member, and the biasing member may include a spring to bias the rotatable mower member.

The mower may include a hitch connecting member to connect to the frame member, and mower may include a long arm member to connect to the rotatable mower member.

The long arm member may be connected to a movable arm member to move the rotatable mower member, and the long arm member may be connected to a traverse arm member.

The rotatable mower member may include a round shaft member to allow the rotatable mower member to move in and out and under the fence and around the obstacle, and the rotatable mower member may include a hydraulic mower.

The rotatable mower member may include a blade, and the rotatable mower member may include a blade mounting plate member to mount the blade.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the frame member;

FIG. 2 illustrates an end view of the frame member;

FIG. 3 illustrates a side view of the channel that connects to the frame member in FIG. 1 to connect to the hydraulic cylinder;

FIG. 4 illustrates a side view of the strap that to hold the hydraulic cylinder;

FIG. 5 illustrates a back view of the swingarm member;

FIG. 6 illustrates a top view of the mower deck member;

FIG. 7 illustrates a back view of the slide arm member;

FIG. 8a illustrates a bushing member;

FIG. 8b illustrates the spring support arms that push the mower back under the fence;

FIG. 9 illustrates mounting stobs to connect the spring support arms FIG. 8b;

FIG. 10 illustrates the spring mounting bracket;

FIG. 11 illustrates a side view of two stobs is connected to the top of the frame member for the top link of the tractor to hook up to;

FIG. 12 illustrates a side view of the bearing mounting plate that is connected to the top of the mower deck;

FIG. 13 illustrates a top view of the mower assembly;

FIG. 14 illustrates a top view of the frame member and shows the hydraulic cylinder connected to the frame member and to the swingarm;

FIG. 15 illustrates an exploded view of the mower assembly;

FIG. 16 illustrates a side view of the mower assembly.

### DETAILED DESCRIPTION

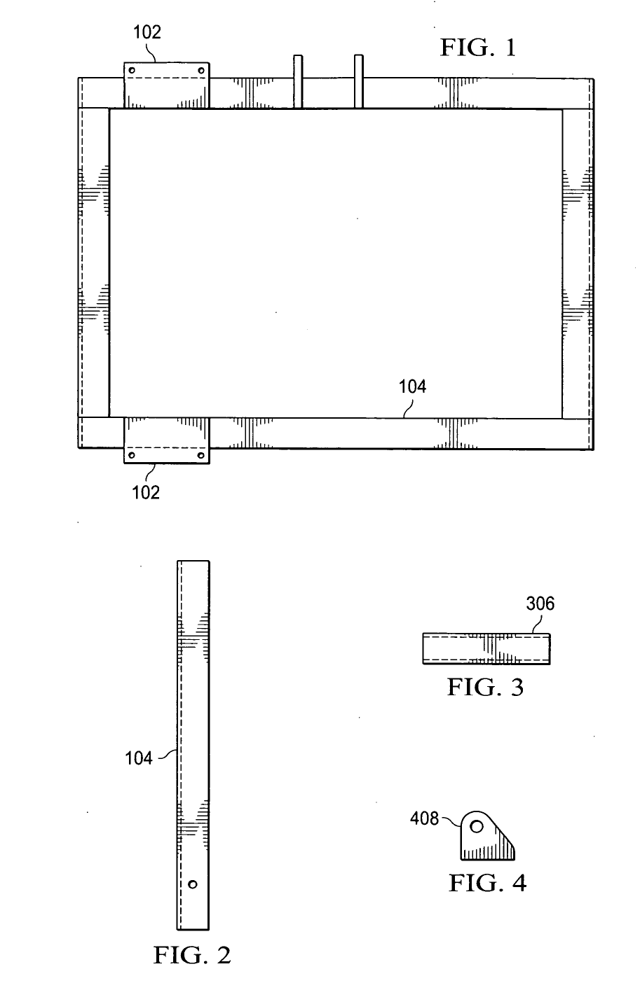

FIG. 1 illustrates a top view of the tractor mounting frame member 104 for connecting to a tractor or other type of vehicle. The tractor mounting frame member 104 additionally includes a mounting bracket member 102 for connecting to a swingarm member 510. The tractor mounting frame member 104 is shown as substantially rectangular.

FIG. 2 illustrates a rear view of the tractor mounting frame member 104.

FIG. 3 illustrates a side view of the of the hitch connecting member 306 which is shown as being substantially rectangular and may be include a channel to connect to the frame member and to connect to the hydraulic cylinder.

FIG. 4 illustrates a side view of a safety connecting member 408 which is connected to the hitch connecting member 306 and includes a channel for connection to the mounting frame 104. The stob member 408 is connected to the hitch connecting member 306 to pin the hydraulic cylinder 1530 to the mounting frame to move the swingarm member 510.

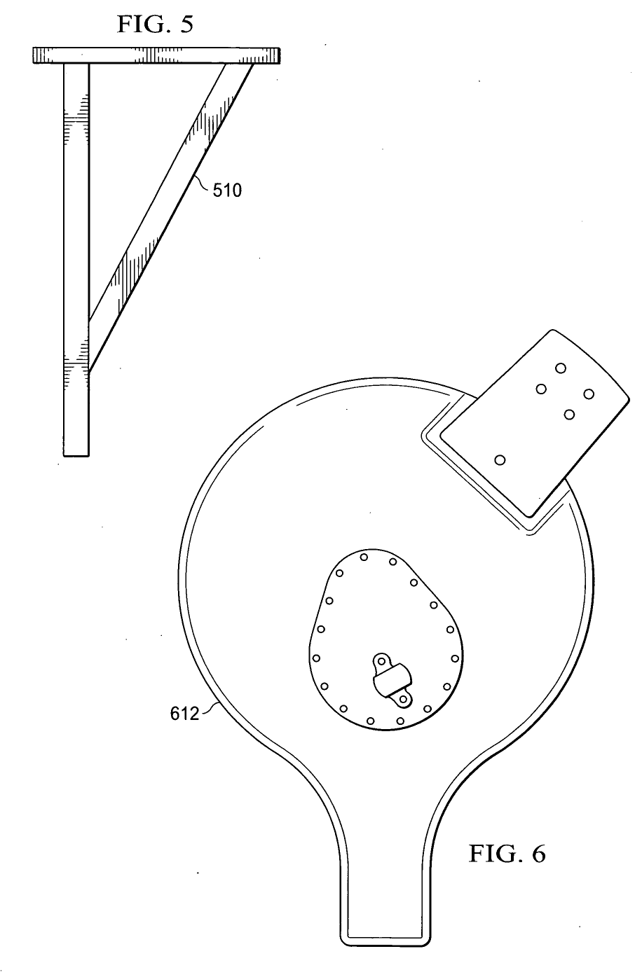

FIG. 5 illustrates a swingarm member 510 to allow the cylinder to swing/rotate the mower away from the fence when turning left or as needed. The swingarm member 510 is substantially triangular shaped.

FIG. 6 illustrates a mower deck member 612 which forms a mower deck.

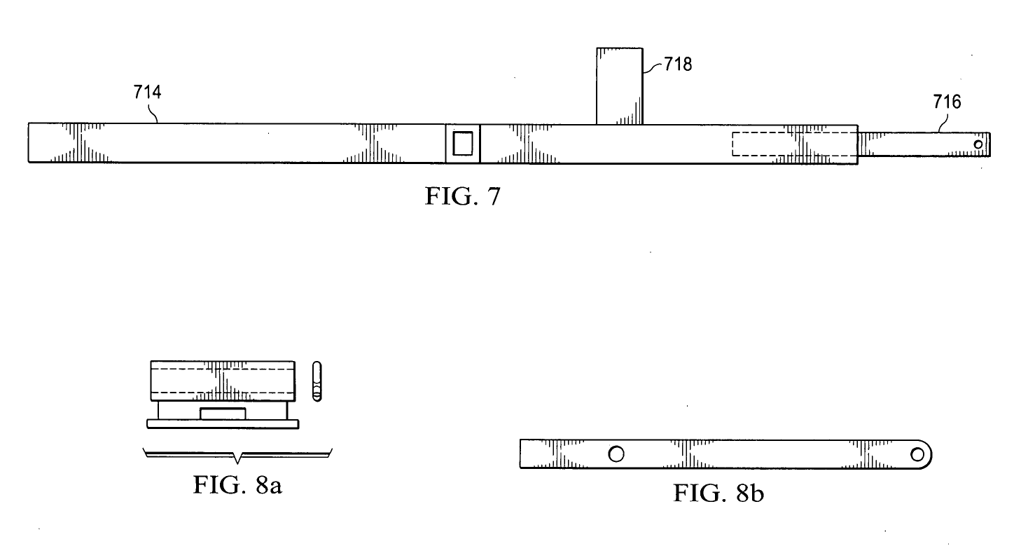

FIG. 7 illustrates that the movable arm member 716 and the traverse arm member 718 are welded to the longitudinal arm member 714 which is clamped to the swing arm member 510. The clamps may be manually released to move in and out to fit different sized tractors. This should be a one time setting. The longitudinal arm member 714 can be moved in and out.

The hydraulic cylinder member 1530 is attached to the stop member 408 that is attached to element 306 which is attached to the element 104. The cylinder is also attached to the swingarm 510.

The long arm member 714, the movable arm member 716 and the traverse arm member 718 are connected together as a main support arm for the complete mower assembly

The bushing member 1532 fits over the movable arm member 716.

FIG. 8a illustrates a bushing member.

FIG. 8b illustrates a spring support arms that pushes the mower back under the fence.

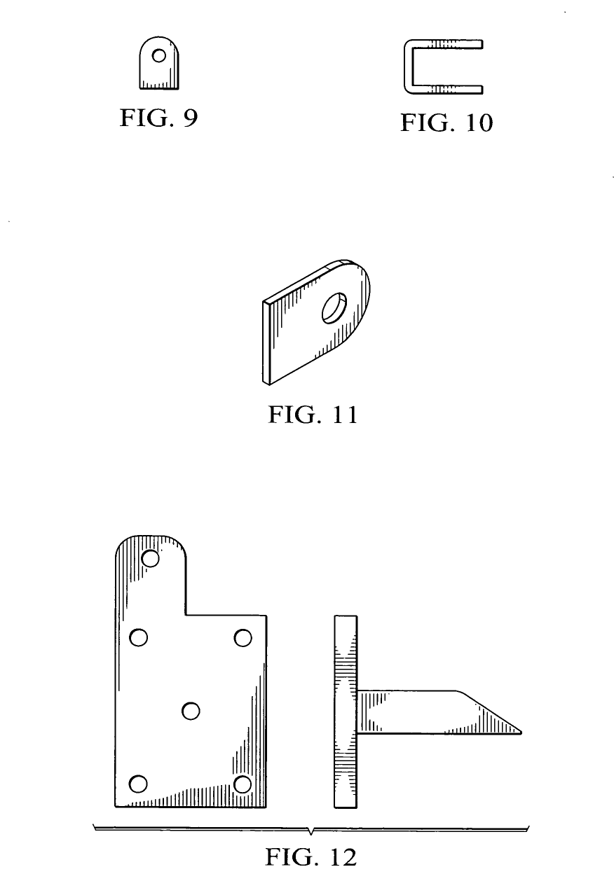

FIG. 9 illustrates mounting stobs for connection to the spring support arms.

FIG. 10 illustrates the spring mounting bracket.

FIG. 11 illustrates a side view of the two stobs which is connected to the top of the frame member for the top link of the tractor to hook up to.

FIG. 12 illustrates the bearing mounting plate 1536 which includes apertures that connects to the top of the mower deck.

The bearing member 1538 are pillow block bearings which may connect to the bearing mounting plate 1536 and fits to a shift connected to the top side of the mower deck member 612.

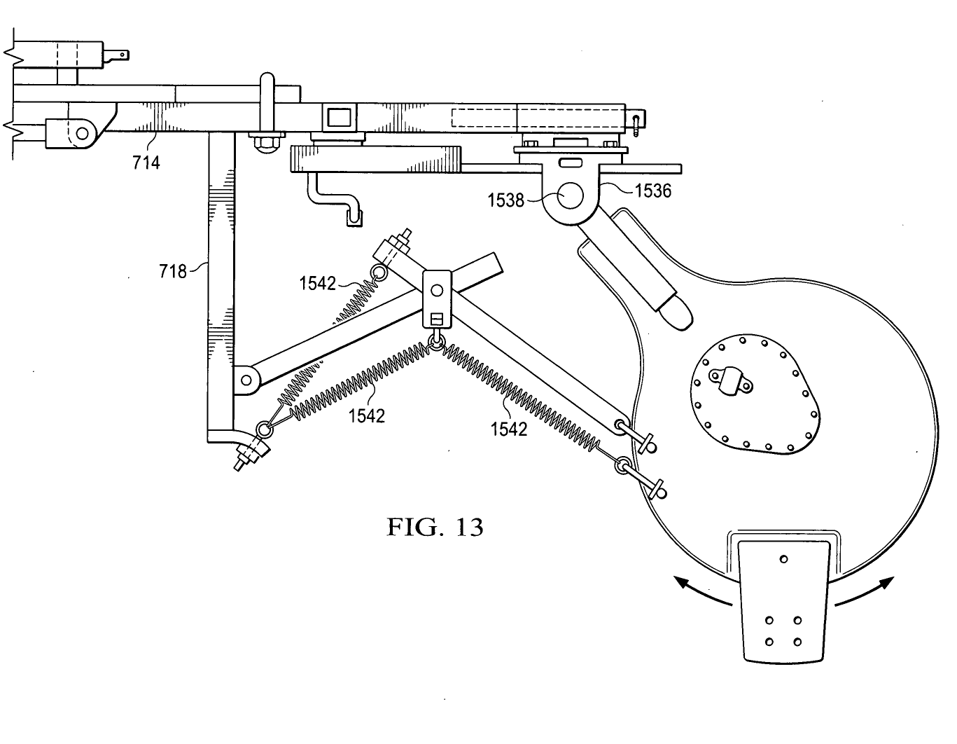

FIG. 13 illustrates a top view of the mower of the present invention. FIG. 13 illustrates the biasing member 1542, the arm member 1544, the bearing mount plate 1536 and the bearing member 1538. FIG. 13 additionally illustrates the traverse arm member 718 and the long arm member 714.

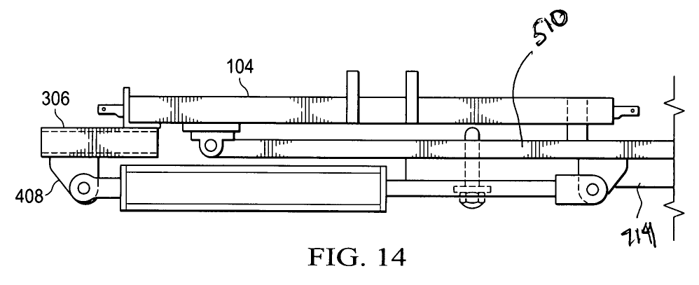

FIG. 14 illustrates a top view of the mower of the present invention and shows the hydraulic cylinder connected to the frame member and to the swingarm. FIG. 14 shows the frame member 104, the hitch connecting member 306 is attached to the frame 104 to support the stob 408 which supports the hydraulic cylinder.

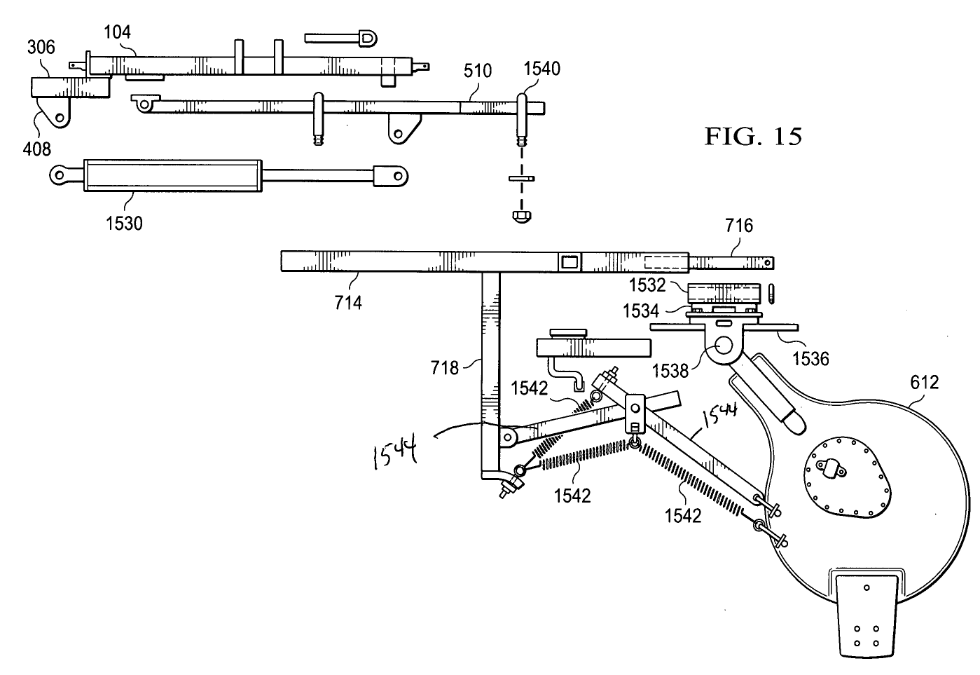

FIG. 15 illustrates an exploded view of the mower of the present invention. FIG. 15 illustrates the frame member 104, the hydraulic cylinder stob 408, support 306, hydraulic cylinder that is also connected to the swingarm member 510, the mower deck member 612, and the longitudinal arm member 714.

FIG. 15 illustrates a hydraulic cylinder member 1530. The cylinder is attached to the mounting frame and the swingarm. FIG. 15 illustrates a bushing member 1532 and a spacer member 1534 which is connected to a bearing mounting plate member 1536 which is connected to a bearing member 1538 to allow the mower deck member 612 to rotate which allows the mower deck 612 to move in and out. Furthermore FIG. 15 illustrates a fastening member 1540 to fasten the longitudinal arm member 714 to the swingarm member 510 and may be a pair of U. Bolts. FIG. 15 illustrates a biasing member 1542 which may be springs to hold the mower member 612 against the fence post and to allow the mower deck member 612 to move in and around the fence post. The biasing member 1542 biases the arm member 1544 to hold the lower deck member 612 against the fence post. The fastening member 1540 which may be a U-bolt to allow the long arm member 714 to be moved in and out for different tractors. The long arm member 714 is connected to the swingarm member 510.

The frame member 104 includes the hitch connecting member 306 which is connected to the frame member 104 and includes the stob member 408 which is connected to the frame member 104. The swingarm 510 includes to pillow block bearings that connect to the frame member 104. The hydraulic cylinder member 1530 is also connected to the swingarm member 510. The long arm member 714 can be extended and retracted by the fastening member 1540 by detachably connecting the long arm member 714. Typically, this adjustment may be a one-time adjustment in order for the mower deck to be placed in the proper position based upon the tractor size that is being used to operate the mower.

The bushing member 1532 slides over the arm member 716 to attach the mower to the long arm member 714. The spacing member 1534 is a spacer that is used to generate a spaced relationship. The slide bar mounting plate is attached to the swingarm. The slide bar slides though the slide bar mounting plate. The hydraulic cylinder is attached to the slide bar. The slide bar latches the swingarm to the tractor mounting frame 104 and is attached to the bearing mounting plate 1536. This levels the mower deck from side to side. It also operates the swingarm, all with one hydraulic cylinder.

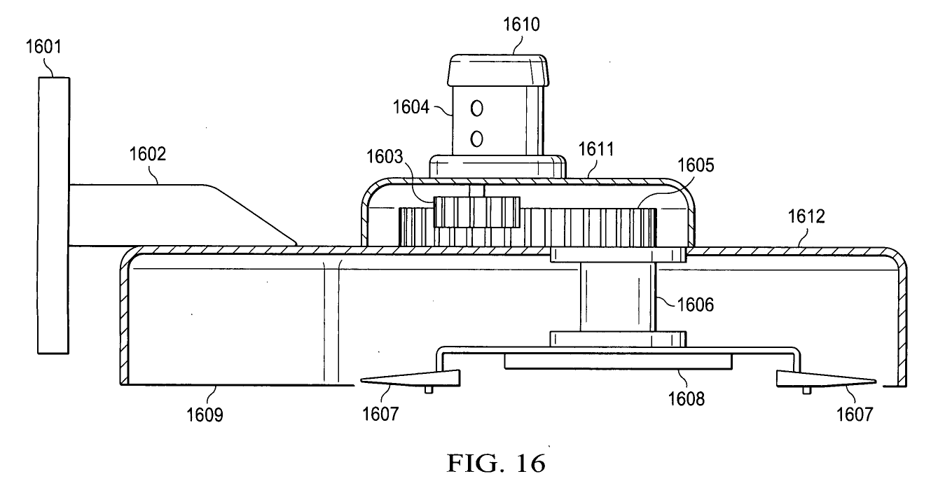

FIG. 16 illustrates a round shaft member 1601 which includes bearings to allow the mower deck to move in and out and under the fence and around the post. FIG. 16 additionally illustrates a tubing member 1602 which is attached to the round shaft member 1601 and is additionally attached to the top of the mower deck 1612. A tooth gear member 1603 is connected to a hydraulic motor 1604. FIG. 16 additionally illustrates a mower shaft member 1605 which may include bearings and a tooth gear member and illustrates a hub member 1606 which is connected to the mower shaft member 1605. A pair of blade members 1607 is connected to a blade mounting plate member 1608 which is connected to the hub member 1606.

A plate member 1609 wrapped around the side of the mower deck 1612 to provide protection from the blades, and an oil reservoir member 1610 for gears. FIG. 16 additionally illustrates a mounting plate member 1611 for the motor and also that for the oil reserve member 1610.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A mower for cutting grass and which is attached to a vehicle, comprising:
a mounting frame member for connecting to the vehicle;
a rotatable mowing member to rotate behind a vertical obstacle;
a swingarm member to connect to the mounting frame member and the rotatable mowing member;
wherein the swingarm member adjustably levels the mower.

2. A mower for cutting grass and which is attached to a vehicle as in claim 1, wherein the mower includes a biasing member to bias the rotatable mower member.

3. A mower for cutting grass and which is attached to a vehicle as in claim 2, wherein the biasing member includes a spring to bias the rotatable mower member.

4. A mower for cutting grass and which is attached to a vehicle as in claim 1, wherein the mower includes a hitch connecting member to connect to the frame member.

5. A mower for cutting grass and which is attached to a vehicle as in claim 1, wherein the mower includes a long arm member to connect to the rotatable mower member.

6. A mower for cutting grass and which is attached to a vehicle as in claim 5, wherein the long arm member is connected to a movable arm member to move the rotatable mower member.

7. A mower for cutting grass and which is attached to a vehicle as in claim 5, wherein the long arm member is connected to a traverse arm member.

8. A mower for cutting grass and which is attached to a vehicle as in claim 1, wherein the rotatable mower member includes a round shaft member to allow the rotatable mower member to move in and out and under the fence and around the obstacle.

9. A mower for cutting grass and which is attached to a vehicle as in claim 1, wherein the rotatable mower member includes a hydraulic mower.

10. A mower for cutting grass and which is attached to a vehicle as in claim 1, wherein the rotatable mower member includes a blade.

11. A mower for cutting grass and which is attached to a vehicle as in claim 10, wherein the rotatable mower member includes a blade mounting plate member to mount the blade.
